(19) United States
(12) Patent Application Publication
(10) Pub. No.: US 2012/0162253 A1
(43) Pub. Date: Jun. 28, 2012

(54) SYSTEMS AND METHODS OF INTEGRATING VIRTUAL FLYOVERS AND VIRTUAL TOURS

(76) Inventor: David Collins, San Diego, CA (US)

(21) Appl. No.: 13/412,546

(22) Filed: Mar. 5, 2012

(51) Int. Cl. G09G 5/00; H04N 11/02

(52) U.S. Cl. 345/629; 375/240.01; 375/E07.026

(57) ABSTRACT

Integration of a virtual flyover and a virtual tour of a location through creation of a combined video sequence are provided. The combined video seamlessly transitions a virtual flyover of an area into a virtual tour of the interior of an object, such as a house or building. Sequences of images corresponding to the virtual flyover or even a proprietary virtual flyover file format are converted into a video file format and then combined with a sequence of images from the virtual tour to create a combined video of the virtual flyover and virtual tour. The combined video labels locations of interest through the video, provides narrations and can also integrate a street-level view into the combined video to provide a user with a singular video tour of a location of interest and a surrounding area which may be viewed on any computer, portable electronic device or television.

### FIELD OF THE INVENTION

The field of the invention relates to virtual flyovers of the earth and virtual tours of a piece of property, and more specifically to systems and methods of providing an integrated virtual flyover and virtual tour of the earth and a specific piece of property.

### BACKGROUND

A virtual flyover is typically a software program which provides a user with a simulated aerial view of the earth on a display as would be seen from a plane or a helicopter. The virtual flyover allows the user to virtually navigate across the earth in any direction and at any elevation. The software program may use one or more maps as the basis for the flyover view, such as a set of aerial images captured by a satellite, plane or helicopter, or an illustrated topographical map of various elevations, vegetation, roads, etc.

A limitation of any virtual flyover software program is its lack of detail at the surface of the earth, as the images used in the virtual flyover map may have been taken by a satellite in space or an aircraft flying high above the earth. The images are two-dimensional (“2D”) and taken from a particular angle with respect to the surface of the earth, which limits the view of objects which rise above the surface of the earth, such as houses, buildings and trees. On a larger scale, hills, mountains and canyons may also be obscured because of an angle at which a particular image device is oriented above the earth. For example, an imaging device which captures an image of the earth directly above a house will only capture the roof line of the house, while the sides of the house are hidden from view. If the imaging device captures the image of the earth from a particular angle away from the angle directly above the house (sometimes referred to as an oblique angle), the image will capture one or possibly two sides of the house and only a portion of the roof line. However, the oblique angle will still obscure at least two sides of the house and a portion of the roof line. For a user that wishes to see a detailed view of a house from all angles, the aerial views provided in a virtual flyover program are inadequate.

In addition, any virtual flyover program cannot provide a view from an interior of an object, such as the interior of a house or a building. A software program known as a “virtual tour” provides images of the interior of a house by collecting images taken of the interior of the house into a single graphical user interface (GUI) where the user can move through or around an interior of the house and view portions of the house from different angles. The images in the virtual tour may also be captured by a special imaging device which is placed in a specific room inside the house and rotated about numerous angles to capture multiple vantage points from the specific position. In the GUI, the user can manipulate the image to see any portion of that room—from the floor to the ceiling—from the specific point where the imaging device was placed. The user may then obtain a more complete understanding of the dimensions and layout of a room that would not be available from looking at one picture of the room or even multiple separate images.

The virtual tour is limited in that it only provides a user with a view of a particular location, such as an interior of a house or building. The virtual tour does not provide the user with any viewpoint or understanding of the area around the house or building, such as a street, neighborhood, or even region.

### SUMMARY

Embodiments described herein are directed to systems and methods of integrating virtual flyovers and virtual tours into a combined video which seamlessly transitions a flyover of an area around an object into a virtual tour of the object, such as a house or building. Sequences of images corresponding to the virtual flyover or even a proprietary virtual flyover file format are converted into a video file format and then combined with a sequence of images from the virtual tour to create a combined video of the virtual flyover and virtual tour. The combined video labels locations of interest through the video, provides narrations and can also integrate a street-level view into the combined video to provide a user with a singular video tour of a location of interest and a surrounding area which may be viewed on any computer, portable electronic device or television.

In one embodiment, a method of integrating a virtual flyover and a virtual tour comprises: capturing a first sequence of images from a virtual flyover of an area surrounding an object; capturing a second sequence of images from a virtual tour of the object; converting the first sequence of images and second sequence of images into a video file format; creating a combined video file by combining the video file format of the first sequence of images with the video file format of the second sequence of images; and displaying the video on a display.

In another embodiment, a system of integrating a virtual flyover and a virtual tour comprises: a flyover capture unit which captures a first sequence of images from a virtual flyover of an area surrounding an object; a tour capture unit which captures a second sequence of images from a virtual tour of an interior of an object; a video conversion unit which converts the first sequence of images and the second sequence of images into a video file format; and a video combination unit which combines the video file format of the first sequence of images with the video file format of the second sequence of images to produce a combined video.

Other objects of this invention will become apparent from the specifications, drawings, and by reference to the appended claims. Various objects, features, aspects and advantages of the present invention will become more apparent from the following detailed description of preferred embodiments of the invention.

### BRIEF DESCRIPTION OF THE DRAWINGS

Features, aspects, and embodiments are described in conjunction with the attached drawings, in which:

FIGS. 1A-1G are screen shot images of a virtual flyover created with a map software program which progresses from an initial distant view of a country or region to a final close-up view of an object of interest;

FIG. 2 illustrates a set of screen shots of a three-dimensional (“3D”) building creation program which creates a 3D image of an object on the virtual flyover;

FIG. 3 illustrates an image of a street-level view which can be integrated into a combined video of the virtual flyover and virtual tour;

FIGS. 4A-4D are images of a virtual tour of an exterior and an interior of a house;

FIG. 5 illustrates a method of integrating a virtual flyover and a virtual tour, according to one embodiment of the invention;

FIG. 6 illustrates a system of integrating the virtual flyover with the virtual tour, according to one embodiment of the invention; and

FIG. 7 is a block diagram that illustrates an embodiment of a computer/server system upon which an embodiment of the inventive methodology may be implemented.

### DETAILED DESCRIPTION

The following detailed description is directed to certain specific embodiments. However, it will be understood that these embodiments are by way of example only and should not be seen as limiting the systems and methods described herein to the specific embodiments, architectures, etc. In this description, reference is made to the drawings wherein like parts are designated with like numerals throughout.

Embodiments described herein provide for systems and methods of integrating virtual flyovers and virtual tours into a video which seamlessly transitions a flyover of an area around an object into a virtual tour of the object, provide for capturing a first sequence of images from a virtual flyover, capturing a second sequence of images from a virtual tour, and combining the first sequence and second sequence into a third sequence of images to create a video of a flyover and a virtual tour of an object.

The integration of a flyover and a virtual tour into a single video file format enables a user to easily view the flyover and the virtual tour simultaneously with a single video player application instead of requiring the use of two separate and incompatible applications. Furthermore, the system provides a user interested in a particular object or location with a complete overview of an area around the object or location as well as a detailed overview of the object. The video may be implemented with one or more additional features, including labels of relevant locations and objects, narration of the video, placement of advertisements related to objects and locations in the video, and details regarding the object. Instead of two separate, incompatible applications which are unable to share information, the system described herein provides a single video output which requires no user interaction or manipulation, includes details not available with either individual application, and which can be accessed without the need for individual virtual flyover software or individual virtual tour software. The resulting video may be viewed by a user on a DVD player, a mobile device, a computer, or over the Internet or on any electronic device capable of displaying video.

### Virtual Flyover

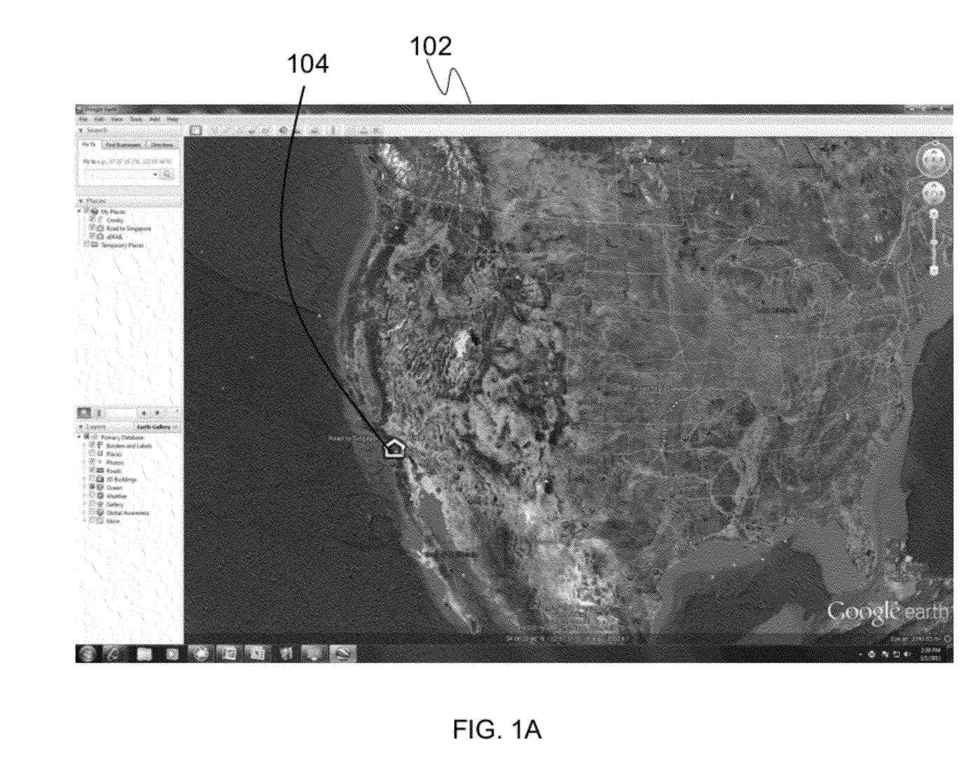

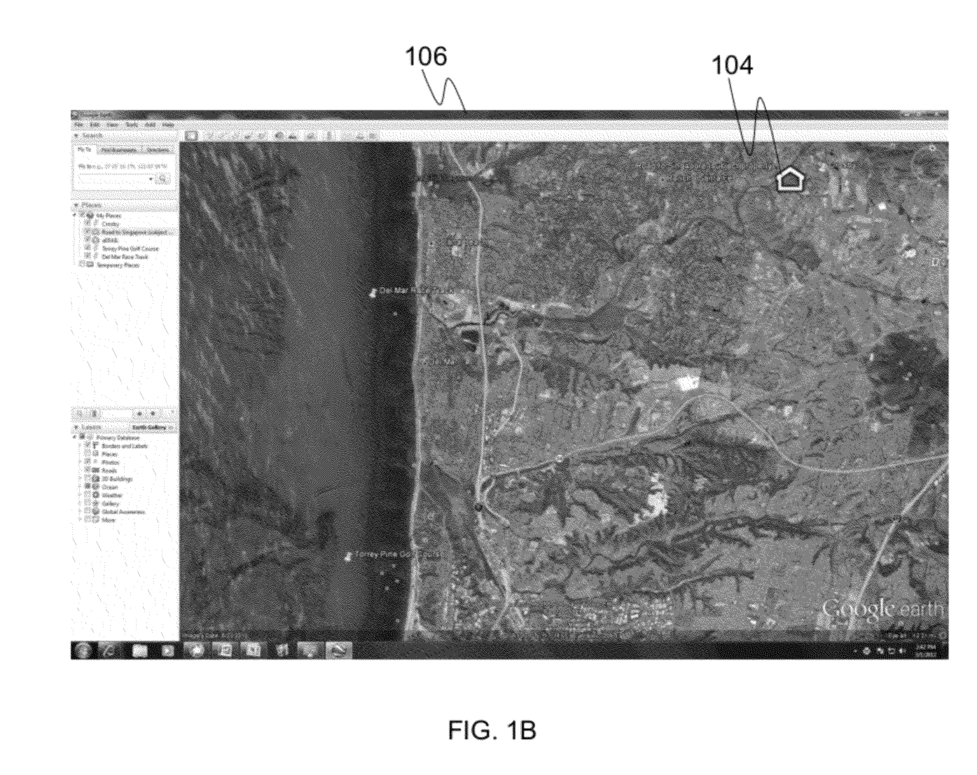

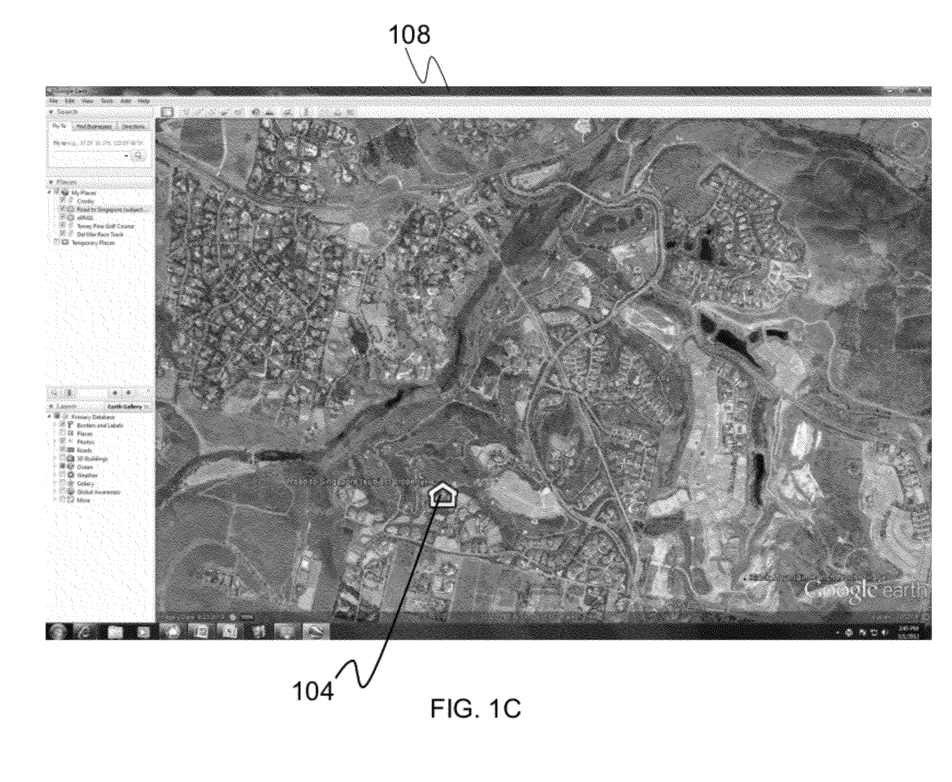

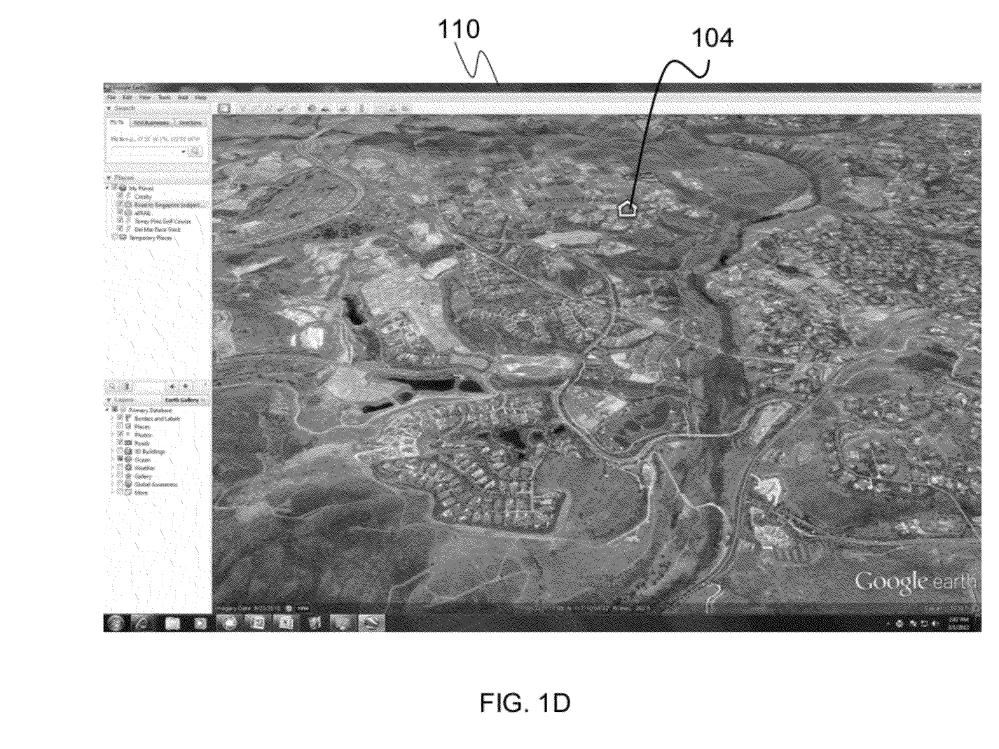

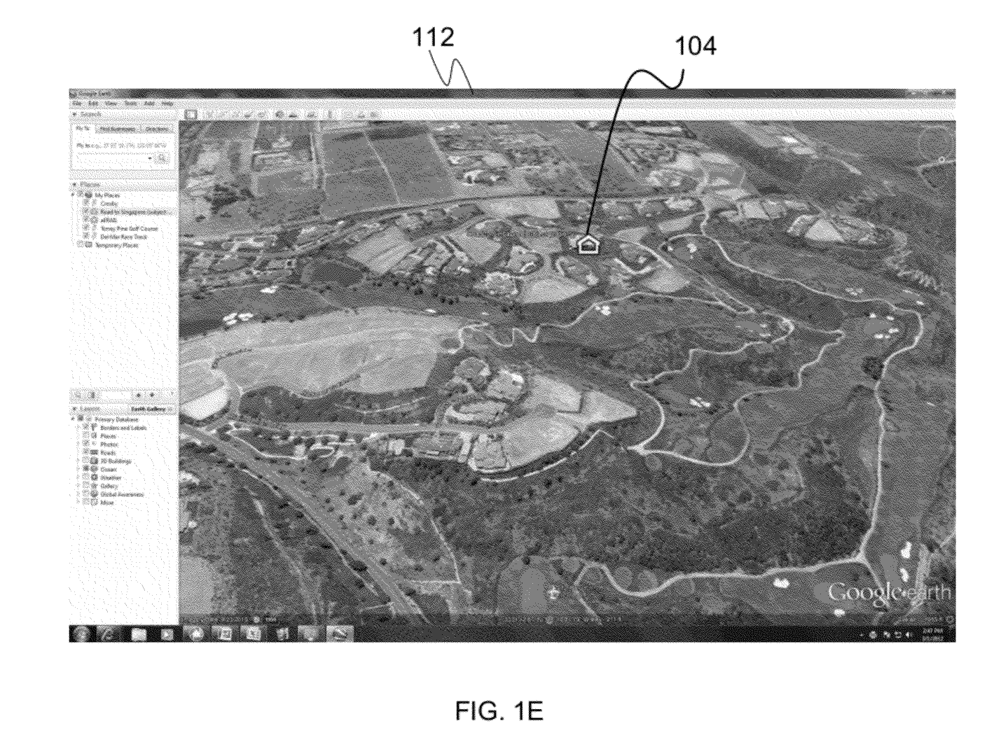

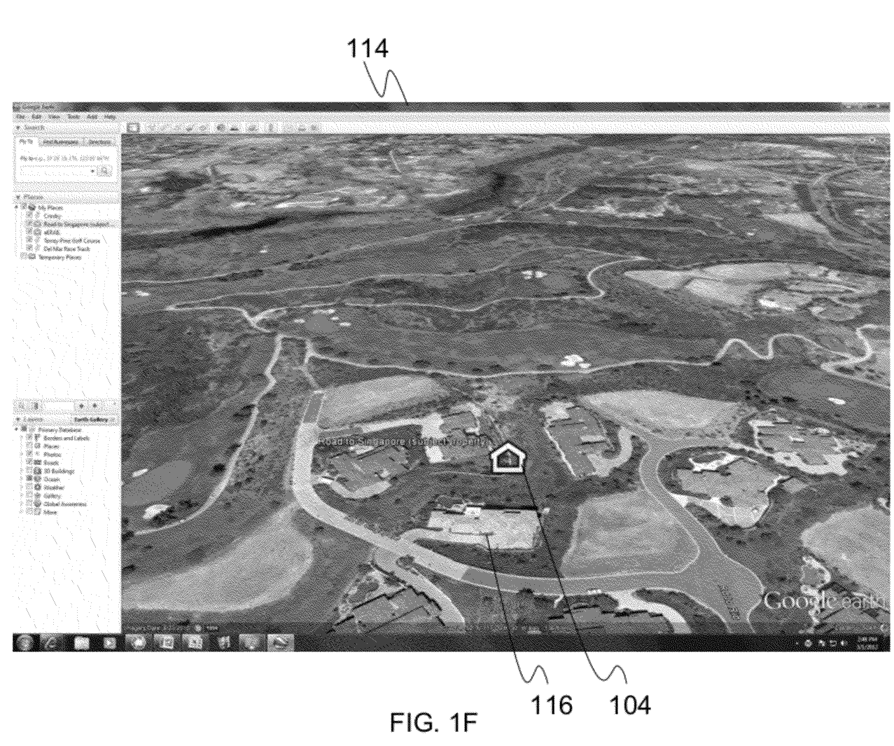

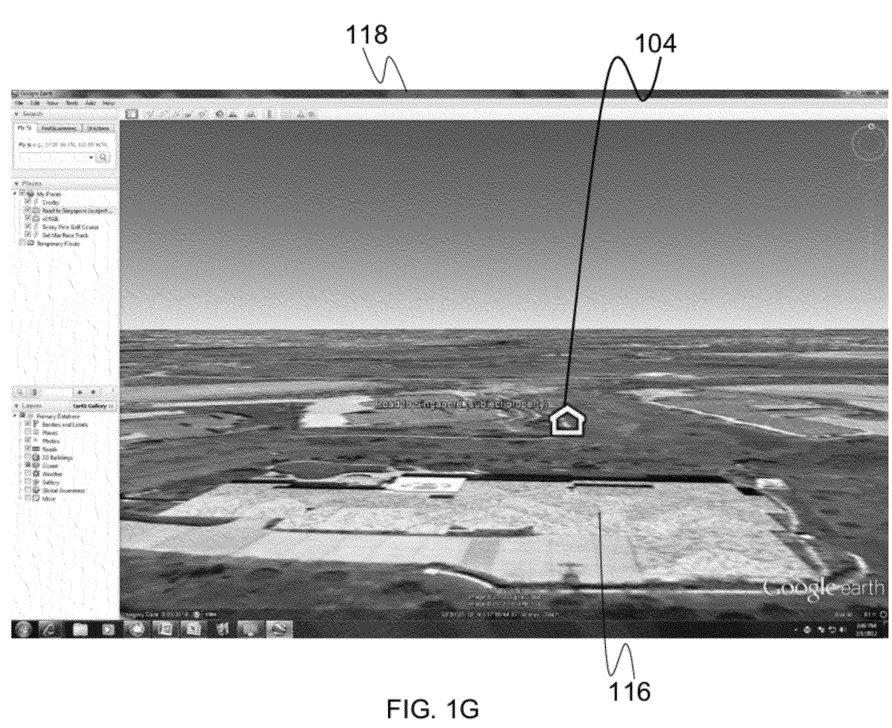

A virtual flyover is an animated simulation of flight over a location on a map that is executed on a computer and displayed to a user on a monitor. FIGS. 1A-1G illustrate a first sequence of satellite images which represent a virtual flyover over a particular location, according to one embodiment. FIG. 1A shows a first image 102 taken from a top-down view of a region or country where an object of interest, such as a house, is located. In the first image 102, the level of detail of the satellite image does not show the house, and so an identifier 104 may be provided over the general area where the house is located. The identifier 104 may be provided on one or more of the first sequence of images to more clearly identify the location of the house if it is not readily apparent on the images. The identifier 104 may be added by the map software during creation of the virtual flyover or during the creation of the video file. FIG. 1B illustrates a second image 106 of a region where the object of interest is located. The second image 106 shows a satellite image which provides a significantly more detailed view of an area around the object of interest, such that streets, topography and some landmarks (such as parks, lakes, and downtown areas) can be identified, and the identifier 106 is still provided to indicate the location of the house. Although the second image 106 shows a much smaller area than the first image 102, the progression of the virtual flyover will provide many more intermediate images between the first image 102 and second image 106 in order to provide a slow animation-like transition between a starting location of the virtual flyover (such as the first image 102) and the final location of the virtual flyover (such as the seventh image 118 in FIG. 1G). Only a small sample of the images of the virtual flyover is illustrated here to show the general progression of the first sequence of images of the virtual flyover. FIG. 1C is a third image 108 of a smaller area surrounding the house, where more detail of an area can now be seen, such as individual neighborhoods, smaller roads, golf courses, etc. FIG. 1D is a fourth image 110 of the same area shown in FIG. 1C, but from a perspective view instead of the top-down view of the third image 108. The perspective view in the fourth image 110 will provide greater detail of the topography and a greater understanding of an area based on the altered depth of objects and landmarks in the image. The map software provides a user creating the virtual flyover with the ability to alter the view into a perspective view of an area from almost any angle, and again will provide many more intermediate images between the third image 108 and the fourth image 110 to provide a smooth transition from the top-down view of the area to the perspective view of the area (which are not illustrated here simply for clarity). FIG. 1E illustrates a fifth image 112 taken from a perspective view which shows a more detailed view of a particular neighborhood where the house is located. Specific streets and other houses around the house are now visible, and more detailed topography and landscaping can be seen. FIG. 1F illustrates a sixth image 114 which is a perspective view of the area around the house 116, which is now clearly visible in the image. The streets and other houses around the house are also clearly visible in the sixth image 114, such that a user can clearly see the type of neighborhood in which the house 116 is located. The identifier 104 may still be placed on or near the house 116 so that a user can identify the house now that the image is clear enough to do so. FIG. 1G is a perspective view seventh image 118 of an area which primarily shows the house 116. The identifier 104 is placed directly “above” the house 116 to identify the specific object of interest.

FIG. 1G shows the limitations of the virtual flyover concept, as this detailed view of the house 116 is still based on a two-dimensional (“2D”) image such that the image of the house 116 shows only the roof line and not any side or other views of the house 116.

Several map software programs provide the ability to create and display virtual flyovers, such as Google® Earth (Google, Inc., Mountain View, Calif.; www.earth.google.com) and Microsoft® Virtual Earth (Microsoft, Inc. Redmond, Wash.; www.microsoft.com/maps). The map software use a proprietary maps database which may include multiple maps of the Earth, including satellite imagery maps, political maps, topographical maps and geological maps. Some map software provides three-dimensional (“3D”) capabilities when representing topography. Map software programs run on proprietary application programming interfaces (APIs) which are generally unique to the particular map software program and not otherwise compatible with any other map software program. Using the API, a programmer can build a customized virtual flyover from one location to another and save it as a file which can be executed only on that specific map software program. For example, Google® Earth uses a proprietary Keyhole Markup Language (KML) to create a virtual flyover, which can only be executed using Google® Earth software. The virtual flyover can be programmed to “fly” along a particular route, change elevations, zoom in or out to focus on particular points along the route, and change the viewpoint during the flyover so that the user is not always looking forward in the direction of movement. The virtual flyover program can be programmed by entering a starting location by name, address, point of interest, longitude and latitude, geo location, etc. A programmer may then draw a line along a route to a final destination, such as the object of interest, and the map software will then execute a flyover animation progression from the starting location to the final destination. The programmer may also create the virtual flyover by navigating through the map program in real-time, using a mouse or a joystick to navigate a particular route and change the views along the way.

In an alternative embodiment, a virtual flyover may be captured manually without the use of map software, such as by recording an actual flyover done with a plane, helicopter or other aerial vehicle (manned or unmanned) with an image capture device on board, such as a video camera or still camera.

In one embodiment, a virtual flyover may be programmed to begin at a starting location on a map that is distant from an object of interest on the map (FIG. 1A) and end at a final destination that corresponds to a location of the object of interest (FIG. 1G). The object of interest may be a house, building, business, neighborhood, park, etc. More specifically, the virtual flyover may begin with an image which simulates a view from a high elevation outside of a particular city or region and slowly zoom in during the flyover until the flyover ends at a detailed, zoomed-in view of the object of interest, as illustrated in the progression of the first sequences of images in FIGS. 1A-1G. During the flyover, additional locations may be shown by zooming in and flying around that location. For example, if a particular city or region is part of the virtual flyover, the flyover may zoom in over specific landmarks or attractions, such as a beach, downtown, mall, theme park, museum, golf course, etc. These additional locations may also be specifically labeled on the map and/or highlighted on the map to stand out to the user during the flyover. The final destination may also be labeled during the flyover. The flyover may also take a path that corresponds to major roads on the way to an object of interest in order to show the route that a user would take to get to the object of interest if they were driving in a car. The virtual flyover is saved into the specific map software in its proprietary file format, such as the KML file used in Google® Earth.

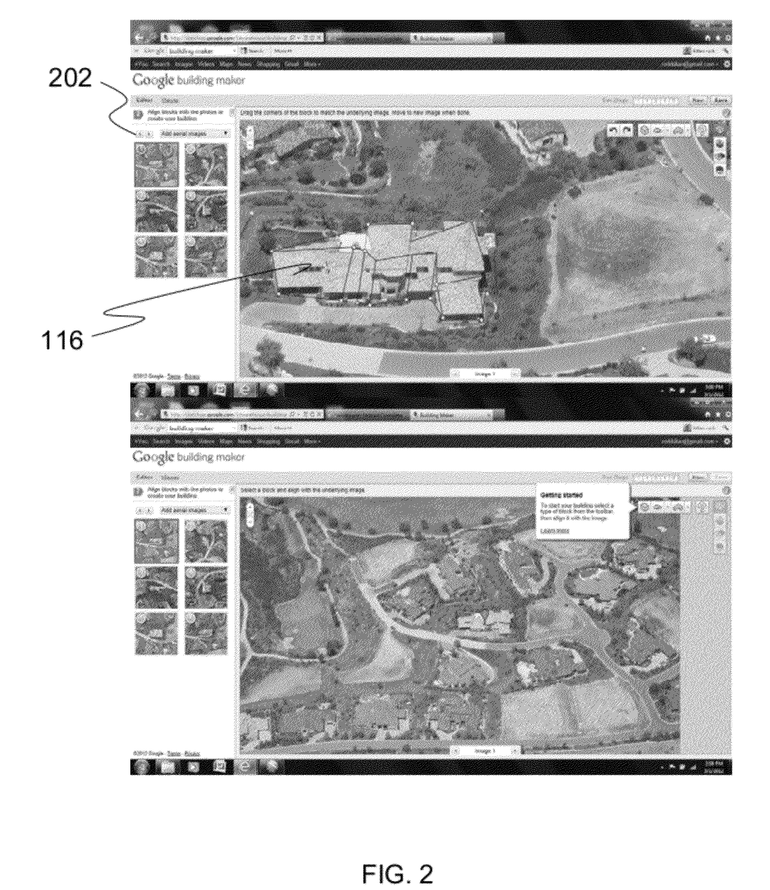

The virtual flyover may also provide a three-dimensional (“3D”) view of certain objects, including houses or buildings, which can be incorporated into the virtual flyover to provide additional detail and perspective of a particular object such as a building or a house. Map software such as Google® Earth provides 3D views of objects, and a third party developer can use 3D modeling software such as the Google® Building Maker or Google Sketch-up® to create a 3D object of a house in a file format compatible with Google® Earth, for example, and submit the 3D object for inclusion in the Google® Earth database. FIG. 2 illustrates screen shots 202 of 3D modeling software which is used to convert a 2D image of the house 116 into a 3D image.

Once the virtual flyover file has been created and stored, the virtual flyover file is converted into a video file format. In one embodiment, specialized software programs herein labeled “video creation tools” are created to convert these formats into video files, such as the Google® Earth Pro Movie Maker Module, which is an add-on to the standard Google® Earth software. The Movie Maker Module converts the KML file format into a video file format, such as MPEG, WMV, AVI, MOV and MP4. In another embodiment, screen capture software may be used to capture the live playback of the virtual flyover as it is displayed on a computer monitor. Screen capture software such as SnagIt (TechSmith® Corp., Okemos, Mich., www.techsmith.com) will capture images of a computer desktop display which can then be converted into an MPEG-4 video format. With screen capture software, the map software can execute the virtual flyover as a full-screen animation, which is then captured by the screen capture software on a frame-by-frame basis and saved into a video file format, such as those discussed above. Other software programs may be available to convert the proprietary map formats into video files, so this list herein is not to be considered exhaustive by any means. Narrations may be added to the video to provide explanations of the locations highlighted in the virtual flyover, and music may be added to enhance the user experience.

In one embodiment, the video creation tool may be running on a first computer while the virtual flyover software is running on a second computer connected with the first computer. The second computer may be connected to an output display port of the first computer with the virtual flyover software. In another embodiment, the video creation tool resides on the first computer along with the virtual flyover software, so that communication between the virtual flyover software and the video creation tool is seamless. Regardless of the particular methodology, the video creation tool outputs a video file format of the virtual flyover which captures the complete virtual flyover from the starting location to the final destination.

By converting the virtual flyover into a video file format, the user is no longer bound to the virtual flyover software, which may be incompatible with software which displays the virtual tours (described below). The video file may be stored on a hard disk drive (HDD) of a computer with a connected display, a portable electronic device such as a smart phone or tablet, a computer-readable media such as a digital versatile disc (DVD), or even a portable HDD or solid state drive (SSD). As video files are almost universally compatible with some type of movie or media player software on a computer, the versatility of a video file of the virtual flyover is significantly greater, as it can be played on a variety of devices and saved into a variety of formats. If the video file is stored as a DVD, the video can be displayed on a television connected with a DVD player. Additionally, the video may be easily embedded into a website using QuickTime® (Apple, Inc., Cupertino, Calif.; www.apple.com/quicktime), Java® (Oracle Corp., Redwood Shores, Calif.; www.java.com) or Adobe® Flash (Adobe Systems, Inc., San Jose, Calif.; www.get.adobe.com/flashplayer) or uploaded to a website for public display, such as YouTube®. A user can then stream the video from any computer or portable device over a network such as the Internet. Furthermore, with the virtual flyover as a video file, the user does not need to manually navigate the virtual flyover software to determine the particular views, maps, elevations and other settings that constitute the virtual flyover of a particular region en route to an object. The use of a video file thus simplifies the virtual flyover.

### Street View

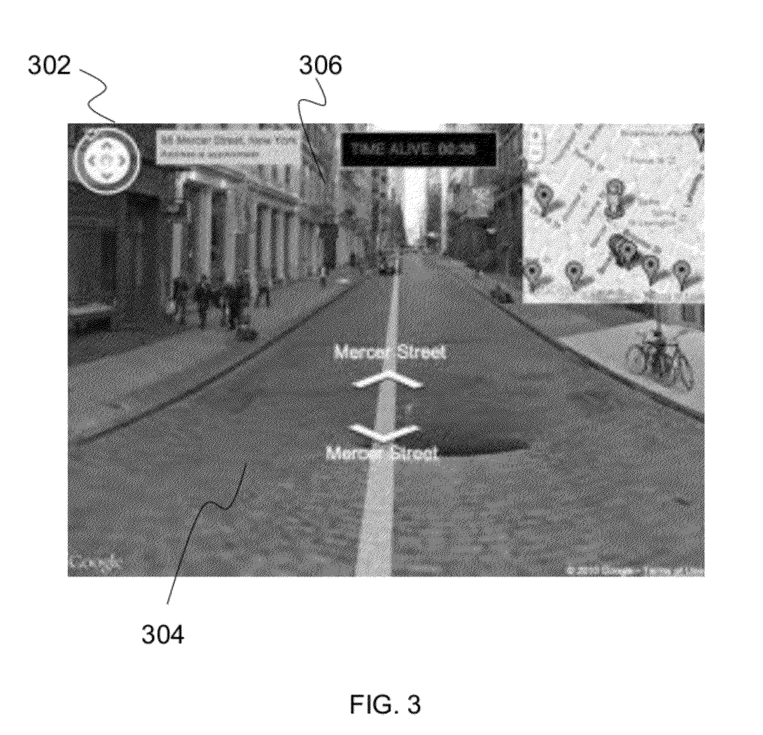

In one embodiment, a street-level view may be incorporated into the combined video to provide further details of a location as shown from a street or path. Software such as the Google® Maps Street View or the Microsoft® Streetside View provide images of a street taken from multiple angles along the length of an entire street. FIG. 3 illustrates one embodiment of a street-level view image 302 that could be included in a combined video of the virtual flyover and virtual tour. The street-level view image 302 illustrates a street 304 with a three-dimensional (“3D”) view of surrounding buildings 306, and a third sequence of images may be included in the combined video which correspond to movement along the street 304. Images from these street-level views could be captured and implemented into the combined video using the video editing software described above.

The use of street-level views may increase the understanding of a particular location and surrounding area to a user, and the export of the street-level images to the combined video simplifies the user experience by allowing the user to see a virtual flyover, a street-level view and a virtual tour in a single video format on a single application instead of using multiple different applications over multiple different devices.

### Virtual Tour

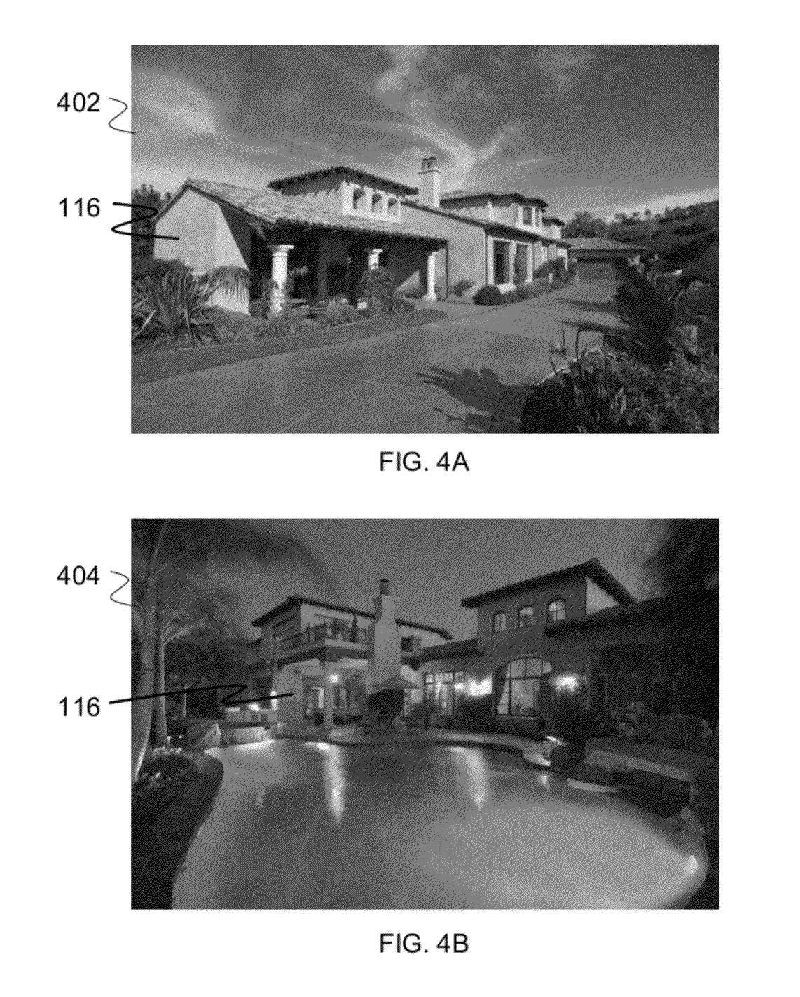

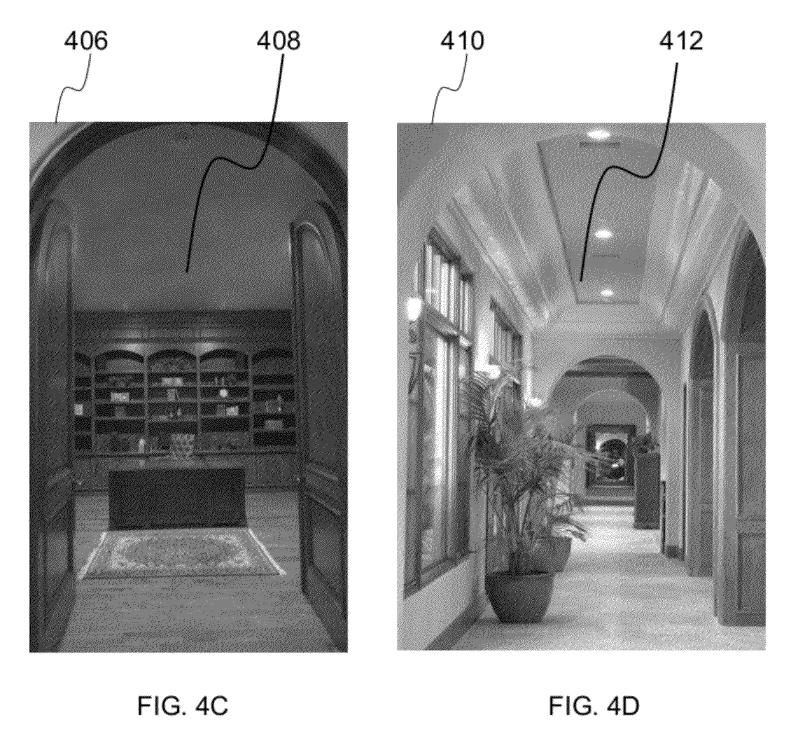

A virtual tour is a simulation of a walk-through of a location using a sequence of images taken of the location. The virtual tour simulates the process of a user walking through the location, which may be a house or building, by capturing images of the location from numerous different points at the location and often from numerous different viewpoints at each point. The virtual tour may be a sequence of images of the interior and exterior of a house which capture various rooms of the house and exterior views of the house and surrounding property. FIGS. 4A-4D illustrate a second sequence of images of a virtual tour of a house such as would be found in a virtual tour. FIG. 4A is a first exterior image 402 of the house 116 taken from a front perspective of the house 116 and which illustrates the front and side elevations of the house 116. FIG. 4B is a second exterior image 404 of the house 116 taken from a rear perspective view of the house 116 which illustrates a rear elevation of the house 116. FIG. 4C is a first interior image 406 of an interior of the house 116, showing an office 408 within the house. FIG. 4D is a second interior image 410 of the interior of the house 116, showing a hallway 412 within the house 116. A plurality of additional images may be provided in the second sequence of images that makes up the virtual tour of the house, although they are not all illustrated here for clarity. The second sequence of images may include additional images of other rooms in the house and may include additional images of the same rooms already depicted, as will be further described below. In one embodiment of a virtual tour, a number of different images of a single room may be taken from a single point and depicted in sequence to provide a more complete view of the single room from numerous different angles, as will be described further below.

In one embodiment, the virtual tour is a combination of numerous images taken from a single point at the location but from different viewpoints at that single point. The single point may be a central point of a living room of a house, and an imaging device may capture a sequence of images of the entire living room from the central point in the living room, such that the sequence of images capture all of the walls, ceiling and floor of the room from the central point. The images may be panoramic or taken with a special lens (such as a fish-eye lens) to provide a wide-angle view of the areas of the house. The images are then combined into a single, unbroken combined image of the entire living room from the central point, and that combined image may then be presented to the user in an interactive viewing window. The user may be initially presented with only a partial image of the combined image of the living room, but can then rotate the combined image at any angle to view any portion of the living room on the combined image. In a virtual tour of a house, a set of images may be captured for each room of the house, creating numerous combined images which can then be presented to the user in a graphical user interface (GUI) for selecting and viewing different combined images of the interior and exterior of the house. The virtual tour thus provides the user with a simulated experience of standing inside of each room of the house and being able to turn and face any direction to experience the full scope of the living room.

In another embodiment, the virtual tour may be a video-based sequence of images which actually simulate a person walking through the house. The sequence of images may be captured by a still frame camera which captures numerous images at small time intervals or by a video camera. The user may be presented with a viewing window which allows them to move through the sequence of images or play the video in order to tour the house. The video-based sequence of images does not focus on capturing every portion of a room, but instead focuses on simulating the user experience of walking through the house.

Depending on the type of virtual tour, the capturing of a second sequence of images of the virtual tour to create a video file varies. If the virtual tour is a simple sequence of images of the interior and exterior of the house, the sequence of images can be easily combined into a video file using any type of video creation software. In one embodiment, a video includes one or more of panning, tilting and zooming of one or more of the sequence of images, which provides the user with the feel of moving through the location depicted in each image even though the image is still and the overall perspective does not change. The video of the virtual tour may also provide labels or highlighting of various features in the house, similarly to the virtual flyover, which can be added during creation and editing of the video of the virtual tour or later on during the combining of the virtual flyover video and virtual tour video. Narration and music may also be added to the virtual tour video at either of these points.

If the virtual tour is the combination of numerous images taken from a single point, the video of the captured sequence of images may include a programmed rotation of the combined image in each room of the house and the programmed rotation of the combined image of any exterior portions of the house. This video file provides the user with a simplified animated sequence of images in a video format without requiring specialized software for playing the video tour and without requiring the user to manually manipulate the combined images of each point inside and outside of the house.

If the virtual tour is already a video-based sequence of images that simulate a person walking through the house, little or no conversion of the existing video is required. For example, an existing video may only need to be formatted into a different video file format that is compatible with the virtual flyover video file format, or the virtual tour video may be edited by video editing software to remove irrelevant portions or enhance the video with additional images.

As with the virtual flyover, the video of the virtual tour may include labels identifying different objects and locations in the house, such as particular rooms, features or other notes about the property. The virtual tour video may also be narrated by a person to provide additional information to the user as they are watching the video. Music may also be added to provide a particular ambience or mood to the user that may be relevant to the location.

To create the video, the virtual tour is started in virtual tour software and a second sequence of images that represents the virtual tour can be captured by a video creation tool running on a computer, such as QuickTime®, Picasa® (Google, Inc., Mountain View, Calif.) or Windows® Movie Maker (Microsoft, Inc., Redmond, Wash.). The video creation tool may be running on a computer where the virtual tour software is running, or on a separate computer connected with the computer where the virtual tour software is running. The video creation tool may reside on a computer which is connected to an output display port of the computer with the virtual tour software, or, if the video creation tool is resident on the same computer, it may simply capture images that are output to the resident display of the same computer. In one embodiment, the video creation tool may capture the complete virtual tour from a beginning point outside the house to an ending point in a room of the house.

### Combining the Virtual Flyover and Virtual Tour Videos

Once videos are created of both the virtual flyover and the virtual tour, the videos are edited into a single, continuous video which combines the virtual flyover and the virtual tour. The combined video allows the user to simultaneously view the virtual flyover and the virtual tour as a single video using a single software application, such as a video player on a computer with a monitor, a DVD player playing a DVD of the video on a television, a portable device accessing the video over the Internet, etc. Any type of video editing software may be used to combine the virtual flyover video and virtual tour video into a single video file, such as Windows® Movie Maker or Apple® iMovie (Apple, Inc., Cupertino, Calif.), although the type of video editing software may vary depending on the video file format desired.

In one embodiment, the virtual tour may be converted into the combined video with the virtual flyover without first creating a video file format of the virtual tour. In this embodiment, the virtual tour may be simply a sequence of images of a house, and the video editing software may be used to combine the virtual flyover video file with the sequence of images into the final combined video.

The combined video simplifies the viewing of the virtual flyover and virtual tour into a single video which may be viewed on a single application and made available across multiple platforms, such as computers, portable devices, televisions, etc. The combined video file may be uploaded to a server for access by computers from multiple locations, embedded into a website for viewing from any web browser or copied onto a DVD to play on a television.

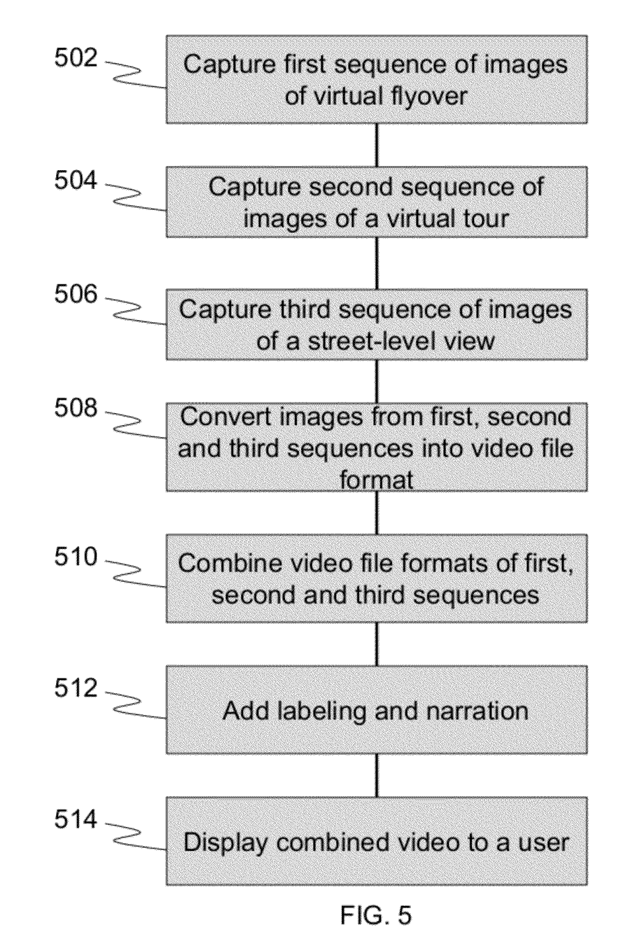

FIG. 5 is a flow chart illustrating a method of integrating a virtual flyover and a virtual tour, in accordance with one embodiment of the invention. In a first step (502), a first sequence of images corresponding to the virtual flyover is captured. The first sequence of images may be captured by obtaining a proprietary file format from map software such as Google® Maps or by using screen capture software to capture images of the virtual flyover as it is displayed on a computer monitor. In a second step (504), a second sequence of images which corresponds to a virtual tour is captured. As described above with regard to the virtual tours, the images in the second sequence may be a basic sequence of images, a complex interlaced sequence of images taken from a central point in a room, or a video sequence of images already in a video file format. In a third step (506), a third sequence of images is captured from a street-level view, using map software which provides street-level images of a particular location of interest. In a fourth step (508), the captured first, second and third sequences of images are converted into a video file format. Details of the conversions of these sequences are provided in the relevant sections above. In a fifth step (510), the converted video file formats are combined into a combined video file using video editing software. In a sixth step (512), labels, narration or music can be added to the combined video file. In a seventh step (514), the combined video may be displayed to a user on a computer monitor, portable electronic device with an integrated display or a television display.

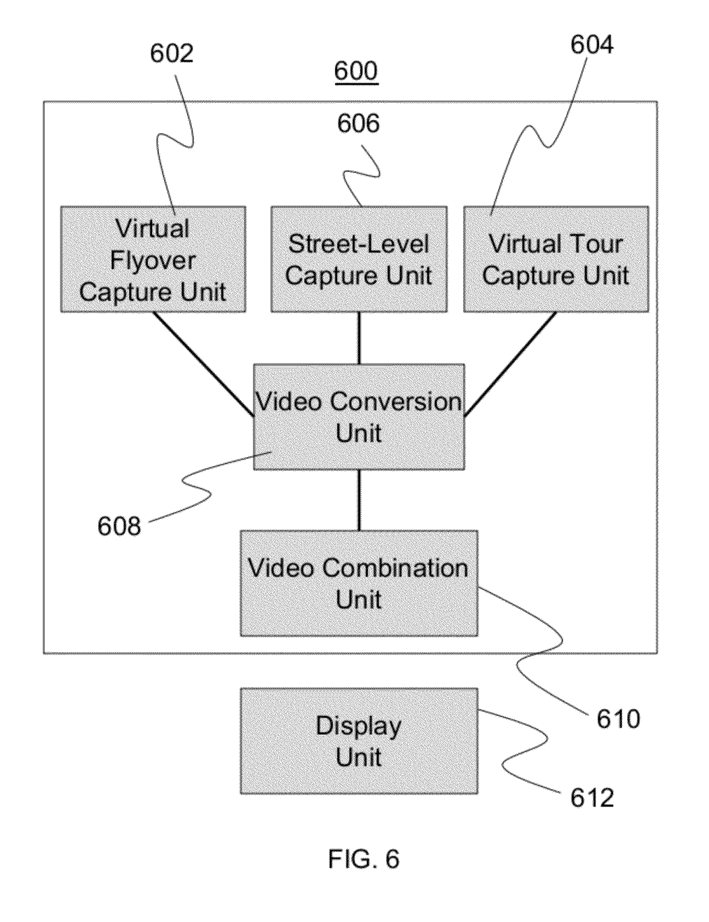

FIG. 6 is a block diagram illustrating a system 600 of integrating a virtual flyover and a virtual tour, in accordance with one embodiment of the invention. A virtual flyover capture unit 602 is provided to capture the virtual flyover, either by obtaining the proprietary file format from a map program such as Google Earth or by using screen image capture software to capture images of the virtual flyover being displayed on a computer monitor. A virtual tour capture unit 604 is provided to capture the images relating to the virtual tour. A street-level capture unit 606 may also be provided to capture images relating to a street-level view of a location of interest. A video conversion unit 608 is connected with the virtual flyover capture unit 602, the virtual tour capture unit 604 and the street-level capture unit 606 to receive the captured images and convert them into video file formats. The video combination unit 608 then combines the converted video file formats into a single video file, for example using video editing software. The video combination unit 608 will also be able to include labels and identifiers on various portions of the video to highlight locations on the virtual flyover or areas of interest on the virtual tour. The video combination unit 608 is also capable of adding narrations and music to the video. The combined video is then output from the system 600 to a display unit 612 to be displayed to a user.

### Applications

In one embodiment, the system may be used by a realtor selling a house to create a combined video of a flyover of an area around the house and a virtual tour of the exterior and interior of the house. The virtual flyover may begin at some location in the city surrounding the house and take a path through the city which highlights certain locations of interest to a potential buyer of the house, such as parks, schools, shopping centers and entertainment areas. The virtual flyover may simply label the locations of interest as it flies over them or it may drop down in elevation and provide a zoomed-in flyover of a particular location. A narration may be provided during the virtual flyover which explains details of the city and the locations of interest, and music may be added to enhance the user experience. The virtual flyover may then zoom out and increase in elevation en route to the final destination of the house. As the virtual flyover nears the house, it may rotate around the neighborhood and zoom in closer to show certain features of the neighborhood, such as a country club, pool or golf course. The virtual flyover will then zoom in and encircle the house to provide a detailed perspective of the house, perhaps showing a 3D view of the house from each side. The combined video may then transition from the virtual flyover to a street-level view of the street where the house is located and provide the user with a simulation of driving up to the house. The combined video will then transition to the virtual tour, providing detailed, panoramic views of the interior and exterior of the house from multiple angles. The narration of the combined video may continue, providing details of the house, including the number of rooms and bathrooms, fixtures and features, details of the building materials, landscaping, etc. The combined video will thus provide a user with a complete overview of not only the house that they are looking to purchase, but also the surrounding neighborhood, locations of interest, etc. which a buyer wants to know before purchasing a house. The combined video provides all of this information on a single display through a single application. The video may be provided on a real estate agent's website, as shown in FIG. 6, on a real estate listing website, provided to the buyer on a DVD to play on their television, or even e-mailed to the buyer to play on their computer, tablet or mobile phone.

One of skill in the art will appreciate that the applications of the combined virtual flyover and virtual tour are not limited to a house or neighborhood. In another embodiment, the system may be used for a business, resort destination or landmark, such as a national monument, museum, hotel or even a golf course. The combined video may even promote an entire region or city and highlight numerous businesses or tourist destinations with virtual tours interspersed between virtual flyover scenes.

### Computer Implementation

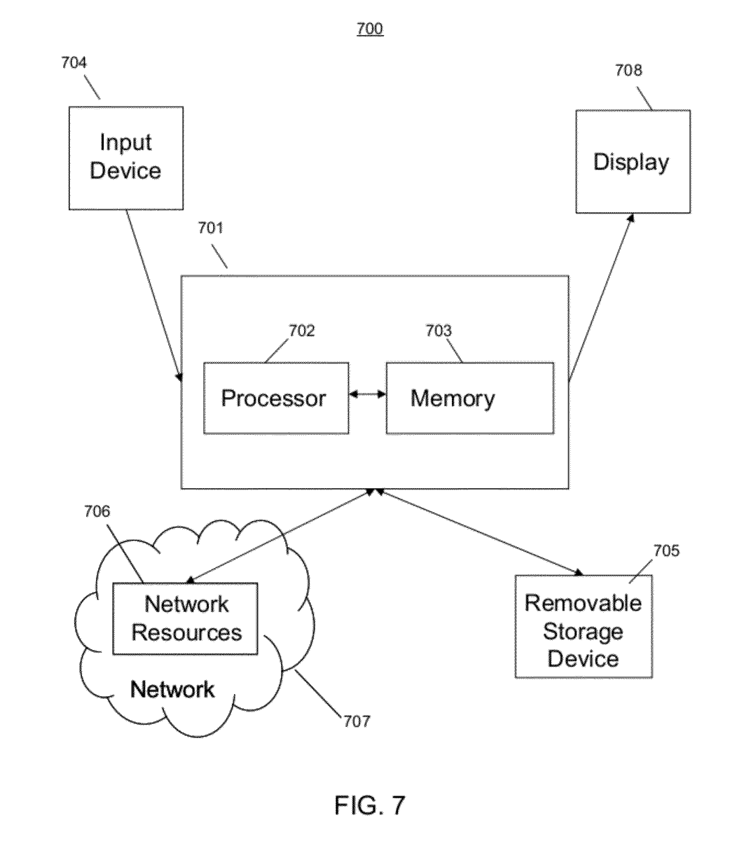

FIG. 7 is a block diagram that illustrates an embodiment of a computer/server system 700 upon which an embodiment of the inventive methodology may be implemented. The system 700 includes a computer/server platform 701 including a processor 702 and memory 703 which operate to execute instructions, as known to one of skill in the art. The term “computer-readable storage medium” as used herein refers to any tangible medium, such as a disk or semiconductor memory, that participates in providing instructions to processor 702 for execution. Additionally, the computer platform 701 receives input from a plurality of input devices 704, such as a keyboard, mouse, touch device or verbal command. The computer platform 701 may additionally be connected to a removable storage device 705, such as a portable hard drive, optical media (CD or DVD), disk media or any other tangible medium from which a computer can read executable code. The computer platform may further be connected to network resources 706 which connect to the Internet or other components of a local public or private network. The network resources 706 may provide instructions and data to the computer platform from a remote location on a network 707. The connections to the network resources 706 may be via wireless protocols, such as the 802.11 standards, Bluetooth® or cellular protocols, or via physical transmission media, such as cables or fiber optics. The network resources may include storage devices for storing data and executable instructions at a location separate from the computer platform 701. The computer interacts with a display 708 to output data and other information to a user, as well as to request additional instructions and input from the user. The display 708 may therefore further act as an input device 704 for interacting with a user.

Those of skill in the art will appreciate that the various illustrative modules, components, engines, and method steps described in connection with the above described figures and the embodiments disclosed herein can often be implemented as electronic hardware, software, firmware or combinations of the foregoing. To clearly illustrate this interchangeability of hardware and software, various illustrative modules and method steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module or step is for ease of description. Specific functions can be moved from one module or step to another without departing from the invention.

Moreover, the various illustrative modules, components, modules, engines, and method steps described in connection with the embodiments disclosed herein can be implemented or performed with hardware such as a general purpose processor, a digital signal processor (“DSP”), an application specific integrated circuit (“ASIC”), field programmable gate array (“FPGA”) or other programmable logic device, discrete gate or transistor logic, discrete hardware components, or any combination thereof designed to perform the functions described herein. A general-purpose processor is hardware and can be a microprocessor, but in the alternative, the processor can be any hardware processor or controller, microcontroller. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm and the functionality of a component, engine, or module described in connection with the embodiments disclosed herein can be embodied directly in hardware, in software executed by a processor, or in a combination of the two. Software can reside in computer or controller accessible computer-readable storage media including RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A method of integrating a virtual flyover and a virtual tour, comprising:
capturing a first sequence of images from a virtual flyover of an area surrounding an object;
capturing a second sequence of images from a virtual tour of the object;
converting the first sequence of images and the second sequence of images into a video file format;
creating a combined video file by combining the video file format of the first sequence of images with the video file format of the second sequence of images; and
displaying the video on a display.

2. The method of claim 1, wherein the first sequence of images is converted from a file format specific to a virtual flyover software program into the video file format.

3. The method of claim 1, wherein the virtual flyover includes a plurality of images representing a three-dimensional (“3D”) view of the object.

4. The method of claim 1, wherein the virtual tour includes a plurality of images of an exterior of the object.

5. The method of claim 4, wherein the virtual tour includes a plurality of images of an interior of the object.

6. The method of claim 5, wherein the combined video begins with the virtual flyover and ends with the virtual tour as it progresses from a location distant from the object to a location proximate the object, and wherein the combined video transitions from the virtual flyover at the location proximate to the object to the virtual tour at an exterior of the object.

7. The method of claim 6, wherein the object is a house.

8. The method of claim 1, wherein creating the video further comprises labeling at least one location in the area with an identifier in the first sequence of images.

9. The method of claim 8, wherein capturing the first sequence of images further comprises capturing a plurality of images from a virtual flyover of the labeled at least one location in the area.

10. The method of claim 1, wherein creating the video further comprises overlaying an advertisement on at least one of the first sequence of images, and wherein the advertisement is for at least one location in the area surrounding an object.

11. The method of claim 10, wherein the at least one location is a business.

12. The method of claim 1, wherein creating the video further comprises labeling the object on the first sequence of images with an identifier.

13. The method of claim 1, further comprising capturing a third sequence of images from a street-level view of a street which is proximate to the object, and further comprising creating the video by inserting the third sequence of images after the first sequence of images and before the second sequence of images.

14. A system of integrating a virtual flyover and a virtual tour, comprising:
a flyover capture unit which captures a first sequence of images from a virtual flyover of an area surrounding an object;
a tour capture unit which captures a second sequence of images from a virtual tour of an interior of an object;
a video conversion unit which converts the first sequence of images and the second sequence of images into a video file format; and
a video combination unit which combines the video file format of the first sequence of images with the video file format of the second sequence of images to produce a combined video.

15. The system of claim 14, further comprising a display unit which displays the video.

16. The system of claim 14, wherein the video conversion unit converts the first sequence of images from a file format specific to a virtual flyover software program into the video file format.

17. The system of claim 14, wherein the virtual flyover begins at a location that is distant from the object and ends at a location of the object.

18. The system of claim 17, wherein the virtual flyover ends with a plurality of images representing a three-dimensional (“3D”) view of the object.

19. The system of claim 17, wherein the virtual tour includes a plurality of images of an exterior of the object.

20. The system of claim 19, wherein the virtual tour includes a plurality of images of an interior of the object.

21. The system of claim 20, wherein the object is a house.

22. The system of claim 21, wherein the video creation unit labels at least one location in the area with an identifier in the first sequence of images.

23. The system of claim 22, wherein the virtual flyover includes a flyover of the labeled at least one location in the area.

24. The system of claim 14, wherein the video creation unit overlays an advertisement on at least one of the first sequence of images, and wherein the advertisement is for at least one location in the area surrounding an object.

25. The system of claim 24, wherein the at least one location is a business.

26. The system of claim 14, wherein the video creation unit labels the object on the first sequence of images with an identifier.

27. The system of claim 26, further comprising a street-view capture unit which captures a third sequence of images from a street-level view of a street which is proximate to the object, and wherein the video capture unit inserts the third sequence of images after the first sequence of images and before the second sequence of images.
